(19) United States
(12) Patent Application Publication
(10) Pub. No.: US 2021/0209313 A1
(43) Pub. Date: Jul. 8, 2021

(54) TRANSLATION METHODS AND SYSTEMS

(71) Applicant: METIS IP (SUZHOU) LLC, Suzhou (CN)

(72) Inventors: Yan LI, Suzhou (CN); Hong QIAN, Suzhou (CN); Hong XUE, Suzhou (CN)

(73) Assignee: METIS IP (SUZHOU) LLC, Suzhou (CN)

(21) Appl. No.: 16/759,388

(22) PCT Filed: Nov. 18, 2019
(86) PCT No.: PCT/CN2019/119249

§ 371 Date: Apr. 27, 2020

(30) Foreign Application Priority Data
Dec. 29, 2018 (CN) 201811636517.4

(51) Int. Cl. G06F 40/42; G06F 40/289

(52) U.S. Cl. CPC G06F 40/42; G06F 40/289

(57) ABSTRACT

The present disclosure embodiment may disclose translation methods and systems. The translation method may include: obtaining a content to be translated in a first language; translating the content to be translated in the first language into a pre-translated content including a second language; correcting the pre-translated content including the second language; and determining a final translated content based on a correction result. The present disclosure may improve the accuracy of machine translation and the efficiency of manual revision by translating part of the content to be translated in advance and correcting and identifying part of the pre-translated content including the second language.

### CROSS REFERENCE

The present disclosure claims priority to Chinese Application No. 201811636517.4, filed on Dec. 29, 2018, the contents of which are hereby incorporated by reference.

### TECHNICAL FIELD

The present disclosure relates to the field of machine translation, and in particular, to translation methods and systems.

### BACKGROUND

With the advancement of science and technology, the amount of information has increased rapidly, and it is necessary to break through language barriers and perform translation between different texts. Machine translation is more and more effective in helping people solve translation problems in different languages. However, at present, there are still problems with inaccurate translation in machine translation, such as the translation of long and difficult sentences, and the translation of words and sentences in professional areas. On the other hand, when using the machine translation to directly translate the entire article, the same words may be inconsistent, and when one or more articles include the same content, the result of the machine translation cannot be guaranteed to be consistent, which increases the time for manual revision and reduces efficiency. Therefore, it is necessary to provide efficient and convenient translation methods and systems that can improve the accuracy of machine translation and the efficiency of manual revision.

### SUMMARY

One of the present disclosure embodiments may provide translation methods. The translation method may include: obtaining a content to be translated in a first language; translating the content to be translated in the first language into a pre-translated content including a second language; correcting the pre-translated content including the second language; and determining a final translated content based on a correction result.

In some embodiments, translating the content to be translated in the first language into the pre-translated content including the second language may include: extracting one or more feature sentences from the content to be translated; obtaining one or more sentence pairs including the one or more feature sentences in the first language and the one or more feature sentences in the second language translated from the first language; and translating the content to be translated in the first language into the pre-translated content including the second language based on the one or more sentence pairs of the one or more feature sentences.

In some embodiments, correcting the pre-translated content including the second language may include: determining whether the pre-translated content includes a high-risk sentence; and in response to a determination that the pre-translated content includes the high-risk sentence, identifying a sentence in the second language corresponding to the high-risk sentence.

In some embodiments, determining whether the pre-translated content includes a high-risk sentence may include: determining whether the pre-translated content includes a sentence with a count of characters or words exceeding a preset threshold; or determining whether the pre-translated content includes a sentence with a count of risk words exceeding a preset threshold.

In some embodiments, the method may further include: translating the first language of the high-risk sentence into one or more translation results in the second languages; determining one or more confidence levels of the one or more translation results in the second language, each of which may correspond to a confidence level; and displaying the one or more confidence levels, or determining a final translated content of the high-risk sentence based on the confidence levels of one or more translation results in the second language.

In some embodiments, the method further may include: performing sentence segmentation on the pre-translated content; and performing sentence return on the final translated content.

One of the present disclosure embodiments may provide translation systems, including an obtaining module, a pre-translation module, and a revision module. The obtaining module may be configured to obtain the content to be translated in the first language; the pre-translation module may be configured to translate the content to be translated in the first language into the pre-translated content including the second language; and the revision module may be configured to correct the pre-translated content including the second language and determine the final translated content based on the correction result.

In some embodiments, in order to translate the content to be translated in the first language into the pre-translated content including the second language, the pre-translation module may be further configured to extract one or more feature sentences from the content to be translated; obtain one or more sentence pairs including the one or more feature sentences in the first language and the one or more feature sentences in the second language translated from the first language; and translate the content to be translated in the first language into the pre-translated content including the second language based on the one or more sentence pairs of the one or more feature sentences.

In some embodiments, in order to correct the pre-translated content including the second language, the revision module may be further configured to determine whether the pre-translated content includes a high-risk sentence; and in response to a determination that the pre-translated content includes the high-risk sentence, identify a sentence in the second language corresponding to the high-risk sentence.

In some embodiments, in order to determine whether the pre-translated content includes a high-risk sentence, the revision module may be further configured to determine whether the pre-translated content includes a sentence with a count of characters or words exceeding a preset threshold; or determine whether the pre-translated content includes a sentence with a count of risk words exceeding a preset threshold.

In some embodiments, the pre-translation module may be configured to translate the first language of the high-risk sentence into one or more translation results in the second language. In some embodiments, the revision module may be configured to determine one or more confidence levels of the one or more translation results in the second language, and each of which may correspond to a confidence level; and display the one or more confidence levels or determine a final translated content of the high-risk sentence based on the confidence level of the one or more translation results in the second language.

In some embodiments, the pre-translation module may be configured to perform sentence segmentation on the pre-translated content; and the revision module may be configured to perform sentence return on the final translated content.

One of the present disclosure embodiments may provide translation apparatuses including at least one storage medium and at least one processor, wherein the at least one storage medium may be configured to store computer instructions; and the at least one processor may be configured to execute the computer instructions to implement a translation method described in the present disclosure.

One of the embodiments of the present disclosure may provide a computer-readable storage medium storing computer instructions. When reading computer instructions in the storage medium, a computer may execute a translation method described in the present disclosure.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary translation system according to some embodiments of the present disclosure;

FIG. 2 is a block diagram illustrating an exemplary translation system according to some embodiments of the present disclosure;

FIG. 3 is a flowchart illustrating an exemplary process for translation according to some embodiments of the present disclosure;

FIG. 4 is a flowchart illustrating an exemplary process for pre-translation according to some embodiments of the present disclosure;

FIG. 5 is a flowchart illustrating an exemplary process for training a model according to some embodiments of the present disclosure;

FIG. 6 is a flowchart illustrating an exemplary process for determining a final translation content according to one of the embodiments disclosed in the present disclosure; and

FIG. 7 is a flowchart illustrating an exemplary process for partially determining a final translated content according to a portion shown in some embodiments of the present disclosure.

### DESCRIPTION

In order to illustrate the technical solutions related to the embodiments of the present disclosure, brief introduction of the drawings referred to the description of the embodiments is provided below. Obviously, drawings described below are only some examples or embodiments of the present disclosure. Those having ordinary skills in the art, without further creative efforts, may apply the present disclosure to other similar scenarios according to these drawings. Unless apparent from the locale or otherwise stated, like reference numerals represent similar structures or operation throughout the several views of the drawings.

It will be understood that the term “system,” “device,” “unit,” and/or “module” used herein are one method to distinguish different components, elements, parts, sections or assembly of different levels in ascending order. However, if other words may achieve the same purpose, the words may be replaced by other expressions.

As used in the disclosure and the appended claims, the singular forms “a,” “an,” and “the” include plural referents unless the content clearly dictates otherwise. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that systems implement according to some embodiments of the present disclosure. It should be noted that the foregoing or the following operations may not be performed in the order accurately. Instead, the operations may be processed in a reverse order or simultaneously. Besides, one or more other operations may be added to the flow charts, or one or more operations may be omitted from the flow chart.

Embodiments of the present disclosure may be applied to different translation systems, including but not limited to a translation system on a client terminal, a translation system on a webpage, etc. The application scenarios of different embodiments of the present disclosure may include but not limited to one or more webpages, browser plugins and/or extensions, client terminals, custom systems, intracompany analysis systems, artificial intelligence robots, or the like, or any combination thereof. It should be understood that application scenarios of the translation systems and methods disclosed herein are only some examples or embodiments. Those having ordinary skills in the art, without further creative efforts, may apply these drawings to other application scenarios.

The “user”, “manual”, and “operator” described in the present disclosure may be interchangeable and refer to the party who needs to use the translation systems. The party may be an individual or a tool.

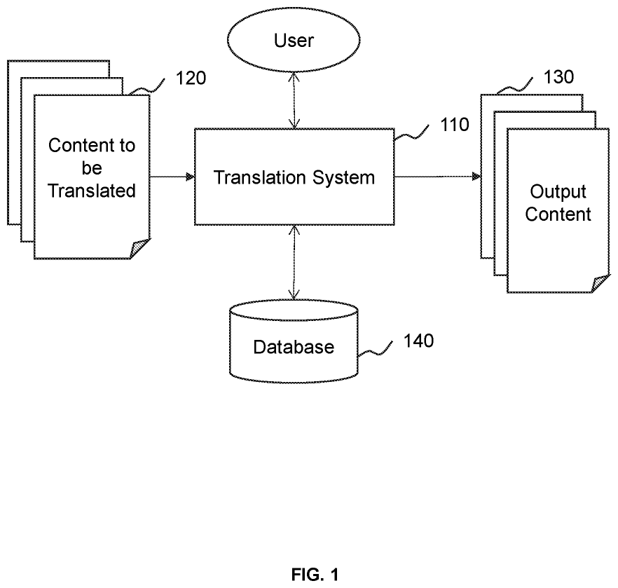

FIG. 1 is a schematic diagram illustrating an exemplary translation system according to some embodiments of the present disclosure.

A translation system 110 may be applied for translation between various languages. The translation system 110 may be used to translate a content to be translated, such as, texts, pictures, voices, and videos, input the content to be translated 120 in a first language, and translate it into an output content 130 in a second language. The content to be translated may be any content that needs to be translated. The translation system may use a database 140 to store relevant corpora, rules and other data.

The first language may be any single language. The first language may include Chinese, English, Japanese, Korean, or the like. The first language may be official languages or local languages of different languages. For example, the Chinese may be simplified Chinese and/or traditional Chinese. The Chinese language may also be Mandarin or dialect (e.g., Cantonese, Sichuan dialect, etc.). The first language may also be languages in different countries of the same language, for example, British English and American English, Johab and Korean.

The second language may be a single language to be finally converted into. The second language may include other languages different from the first language, such as Chinese, English, Japanese, Korean, or the like. The Chinese may be simplified Chinese and/or traditional Chinese. The Chinese language may also be Mandarin or dialect (for example, Cantonese, Sichuan dialect, etc.). The second language may also be a language that belongs to the same language as the first language but used in a different country, for example, British English and American English, Johab and Korean.

Merely by way of example, in this translation system 100, a first language English may be translated into a second language Chinese. A first language simplified Chinese may be translated into a second language traditional Chinese. A first language Mandarin Chinese may be translated into Cantonese. British English may be translated into American English.

The translation system 110 may include a processing device 112. In some embodiments, the translation system 110 may be used to process translation-related information and/or data. The processing device 112 may process translation-related data and/or information to implement the one or more functions described in the present disclosure. In some embodiments, the processing device 112 may include one or more sub-processing devices (e.g., a single-core processing device or a multi-core processing device). Merely by way of example, the processing device 112 may include a central processor (CPU), an application specific integrated circuit (ASIC), an application specific instruction set processor (ASIP), a graphics processing unit (GPU), a paralleling and protection unit (PPU), a digital signal processor (DSP), a field programmable gate array (FPGA), a programmable logic device (PLD), a controller, a microcontroller unit, reduced instruction set computer (RISC), a microprocessor, or the like, or any combination thereof.

The database 140 may be used to store corpora. A corpus refers to one-to-one language pairs corresponding to the first language and the corresponding second language, including, but not limited to, words, phrases, or sentences. In some embodiments, the processing device 112 may automatically align language pairs to form first language and the second language pairs when historical translated contents in the first language and the second language are inputted, and transmit the corpora to the database 140. When the content to be translated is translated, the processing device 112 may obtain the corpora from the database 140 to match the content to be translated.

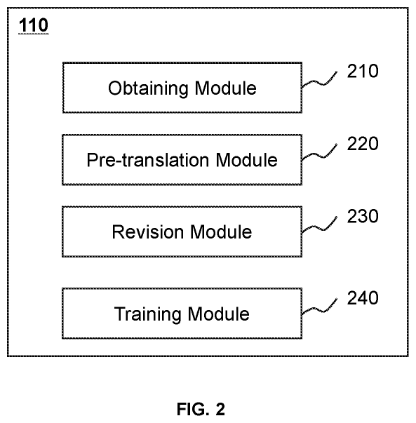

FIG. 2 is a block diagram illustrating an exemplary translation system according to some embodiments of the present disclosure.

As shown in FIG. 2, the translation system may include an obtaining module 210, a pre-translation module 220, a revision module 230, and a training module 240.

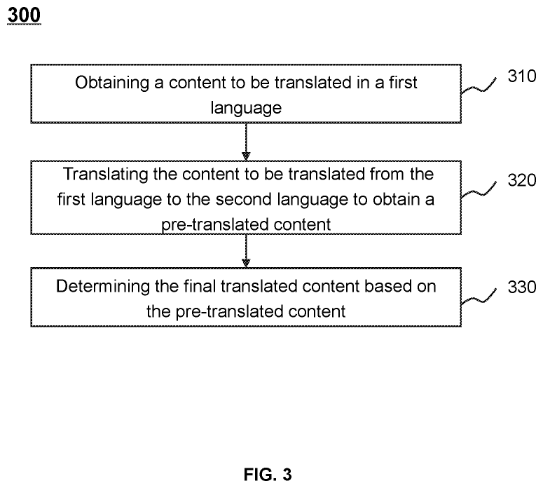

The obtaining module 210 may be configured to obtain a content to be translated in a first language. In some embodiments, the obtaining module 210 may obtain the content to be translated in the first language. More description about the obtaining module 210 may refer to operation 310 in FIG. 3 and description thereof.

The pre-translation module 220 may be configured to initially translate the content to be translated from the first language into a second language to obtain a pre-translated content. In some embodiments, the pre-translation module 220 may extract feature sentences of the content to be translated, and implement the translation from the first language into the second language by matching the feature sentences with corpus. In some embodiments, the pre-translation module 220 may translate the first language into the second language by using a machine learning model. In some embodiments, the pre-translation module 220 may translate the first language into the second language by calling an application plug-in, a component, a module, an interface, or other executable programs.

In some embodiments, the pre-translation module 220 may include a feature sentence extraction unit, a feature sentence translation unit, and a pre-translation determination unit.

The feature sentence extraction unit may be configured to extract feature sentence(s) in the content to be translated. The feature sentence extraction unit may extract the feature sentence(s) based on a matching degree between words, phrases or sentences in the content to be translated and the corpus, a specific rule, a count of words, phrases or sentences present in the content to be translated, a similarity of words, phrases or sentences in the full content of the content to be translated, and other manually determined processes. More description about the feature sentence extraction unit may refer to operation 410 and description thereof.

The feature sentence translation unit may be configured to translate the feature sentence(s) from the first language to the second language. More description about the feature sentence translation unit may refer to operation 420 and description thereof.

The pre-translation determination unit may be configured to translate non-feature sentence(s) in the content to be translated from the first language to the second language to obtain the pre-translated content based on the first language and the second language pair(s) of the feature sentence(s). More description about the pre-translation determination unit may refer to operation 430 and description thereof.

In some other embodiments, a corpus, a translation engine (e.g., Google Translate, etc.), or a machine learning model may be used to translate the remaining content in the content to be translated.

The revision module 230 may be configured to determine a final translated content based on the pre-translated content.

The revision module 230 may correct the pre-translated content (for example, high-risk sentences) including the second language on the basis of the pre-translated content. The correction may be performed by a user or by a program module. The final translated content may be determined by correction.

The revision module 230 may include a high-risk sentence determination unit, a high-risk sentence revision unit, and a format revision unit.

The high-risk sentence determination unit may determine the high-risk sentence(s) based on the content to be translated. For example, the high-risk sentence determination unit may determine the high-risk sentence(s) based on a specific rule, a machine learning model, or other processes. More description of the high-risk sentence determination unit may refer to operation 610 and description thereof.

The high-risk sentence revision unit may identify sentence(s) in the second language corresponding to the high-risk sentence(s) in the pre-translated content. The high-risk sentence revision unit may also determine the final translated content of the high-risk sentence(s) based on the pre-translated content of the high-risk sentence(s). The identifying may include changing a font color, changing a font size, changing a font style, adding symbols, or the like. More description about the high-risk sentence revision unit may refer to operations 620 and 630 and descriptions thereof.

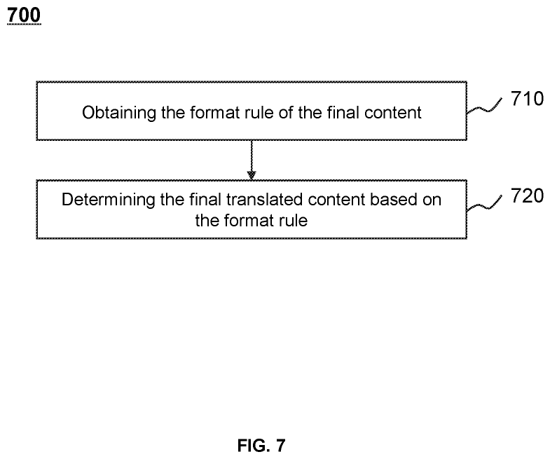

The format revision unit may obtain a format rule of a final content and determine the final translated content based on the format rule. More detailed description about the format revision unit may refer to FIG. 7 and description thereof.

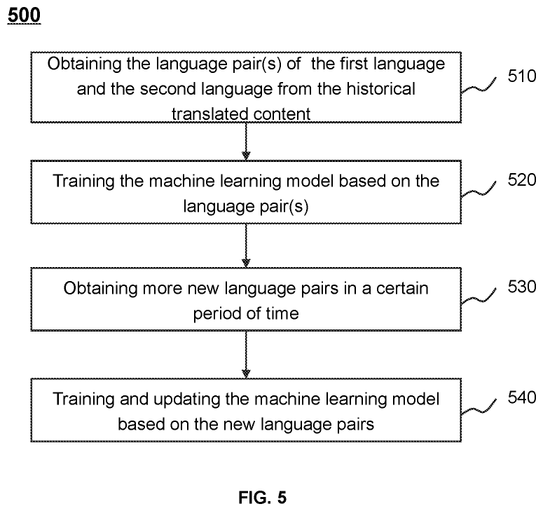

The training module 240 may train a machine learning model (e.g., a machine translation model). The training may be based on the first and second language pairs of historical translation content. The training module 240 may also obtain more new language pairs in a certain period of time, train and update the machine learning model based on the new language pairs. More detailed description about the training module 240 may refer to FIG. 5 and description thereof.

It should be understood that the system and its modules shown in FIG. 2 may be implemented in various ways. For example, in some embodiments, systems and its modules may be implemented by hardware, software, or a combination of software and hardware. The hardware may be implemented using dedicated logic; the software may be stored in a storage medium. The system may be executed by appropriate instructions.

It should be noted that the above description of the translation system and its modules is for convenience of description only, and cannot limit the present disclosure to the scope of the embodiments. For persons having ordinary skills in the art, modules may be combined in various ways or connected with other modules as sub-systems, and various modifications and transformations in form and detail may be conducted under the teaching of the present disclosure. For example, in some embodiments, the obtaining module 210, pre-translation module 220, the revision module 230, and the training module 240 disclosed in FIG. 2 may be different modules in the system, or may be one module that may implement the functions of two or more modules. For example, the pre-translation module 220 and the revision module 230 may be two modules, or may be a module having both a pre-translation function and a revision function. For example, each module may share a single storage module. Each module may also have its storage module. All such modifications are within the protection scope of the present disclosure.

FIG. 3 is a flowchart illustrating an exemplary process for translation according to some embodiments of the present disclosure. In some embodiments, the translation process 300 may be implemented by the processing device 112. As shown in FIG. 3, the translation process 300 may include the steps described below.

In 310, a content to be translated in a first language (i.e., an input content 120) may be obtained. Specifically, operation 310 may be performed by the obtaining module 210.

As described in FIG. 1, the content to be translated may be any content that needs to be translated. The first language may be any single language (for example, Chinese, English, Japanese, Korean, etc.), official languages and local languages of different languages (for example, simplified Chinese (mandarin or dialect), traditional Chinese), languages in different countries of the same language, for example, British English and American English, Johab and Korean or the like, or any combination thereof.

The content to be translated may be a text content, a picture content, a voice content, a video content, or the like, or any combination thereof. In some embodiments, the content to be translated may also be one or more words, one sentence, one paragraph, multiple paragraphs, one article, etc. In some embodiments, the content to be translated may be a content all in the first language or a content mixed of the first language and other languages, such as “ [symbol] USB [symbol] ”.

The obtaining module 210 may obtain the content to be translated in the first language. In some embodiments, a user may input the content to be translated, and the input process may include but not limited to, for example, typing with a keyboard, handwriting input, voice input, or the like.

In some embodiments, the content to be translated may be inputted by importing a file.

In some embodiments, the content to be translated may be obtained via an application program interface API. For example, the content to be translated may be directly read from a storage region on the same device or on the network.

In some embodiments, the obtaining module 210 may obtain the content to be translated by scanning. For example, when the content to be translated is non-electronic, the content to be translated, such as paper text, pictures, or the like, may be scanned and converted into a storable electronic content to obtain the content to be translated.

The above obtaining process is merely by way of example, the present disclosure is not intended to be limiting, and any other obtaining processes known to those skilled in the art may be used to obtain the content to be translated.

In 320, the content to be translated may be translated from the first language to the second language to obtain a pre-translated content. Specifically, operation 320 may be performed by the pre-translation module 220.

As described in FIG. 1, the second language may be a single language to be finally converted into. The second language may include other languages than the first language, such as Chinese, English, Japanese, Korean, Mandarin or dialect (e.g., Cantonese, Sichuan dialect, etc.), British English and American English, Johab and Korean etc. Merely by way of example, the first language English may be translated into the second language Chinese, the first language simplified Chinese may be translated into the second language traditional Chinese, the first language Mandar may be translated into Cantonese, and British English may be translated into American English.

The pre-translated content may refer to a translated content in which the first language of the content to be translated is initially translated into the second language. In some embodiments, that first language of the content to be translated is initially translated into the second language may include translating part of the first language of the content to be translated into the second language. The part of the first language may include the first language of feature sentence(s) of the content to be translated. The pre-translation module 220 may implement the initial translation of the first language into the second language by extracting the feature sentence(s) and translating the feature sentence(s) into the second language. The feature sentence(s) may be extracted based on a matching degree between words, phrases or sentences in the content to be translated and the corpus, a specific rule, the count of words, phrases or sentences present in the content to be translated, a similarity of words, phrases or sentences in the full content, and other manually determined processes, and other manually determined processes. A feature sentence may be a word, a phrase, a short sentence, and/or a sentence. After the feature sentence(s) are extracted, the feature sentence(s) may be translated by a preset rule, a corpus, a constructed machine learning model, an existing translation engine or a user. At this time, the pre-translated content is a mixed content including feature sentence(s) translated into the second language and the untranslated first language. More details about extracting and translating the feature sentence(s) may refer to operations 410 and 420, which will not be repeated herein.

In some embodiments, that first language of the content to be translated is initially translated into the second language may include translating the entire first language of the content to be translated into the second language. The entire first language may include the first language of the entire content to be translated. In this case, the pre-translation module 220 may first extract and translate the feature sentence(s) of the content to be translated, and then translate the remaining first language. For example, after the feature sentence(s) are translated, a remaining content of the content to be translated (i.e., non-feature sentences) may be translated by a corpus, an existing translation engine (e.g., Google Translate, Baidu Translate, Youdao Translate, etc.) or a machine learning model (refer to FIG. 5 and description thereof). At this time, the pre-translated content may be a content that the entire first language is translated into the second language. More details about the translation of the remaining non-feature sentences may refer to the operation 430, which will not be repeated herein.

In some embodiments, in order to translate the entire first language of the content to be translated into the second language, the pre-translation module 220 may directly translate the entire first language of the content to be translated into the second language without extracting the feature sentence(s). For example, the content to be translated may be directly translated by a corpus, using an existing translation engine, or a machine learning model.

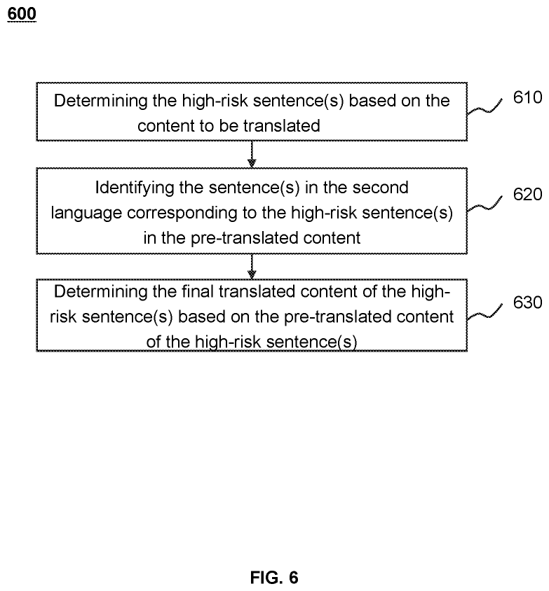

In some embodiments, the pre-translated content may also include the identified second language of part of the content (e.g., the second language of the high-risk sentence(s) that is identified), a plurality of output results in the second language corresponding to some of the second language (e.g., high-risk sentence(s)), which may refer to FIG. 6 and description thereof.

The content generated from the pre-translation may be output separately, or may be displayed in a document in comparison with the content to be translated in the first language.

The format of the pre-translated content may be the same as or different from the format of the content to be translated. In some embodiments, the format of the pre-translated content may be different from the format of the content to be translated. For example, the format of the content to be translated may be a paragraph that includes at least two periods, and the format of the pre-translated content is a content in which the paragraph is segmented by periods. That is, if a passage includes two periods, the content to be translated is one paragraph, and the pre-translated content is two paragraphs.

In 330, the final translated content may be determined based on the pre-translated content. Specifically, operation 330 may be performed by the revision module 230.

The final translated content may include translated content obtained by correcting some of the second language of the pre-translated content, or translated content after adjusting the format of the pre-translated content, or the like, or any combination thereof.

In some embodiments, the revision module 230 may, based on pre-translated content, automatically correct the second language (for example, high-risk sentence(s)) or may provide an input interface for correction by the user to determine the final translated content. The corrected content may include the second language of high-risk sentence(s), or sentence(s) (for example, content in a professional area, etc.) that the user thinks need to be corrected.

In some embodiments, in a case where the entire first language of the content to be translated has been translated into the second language in the pre-translated content, the revision module 230 may adjust the format of the pre-translated content. For example, the pre-translated content may be revised to meet a specific requirement in accordance with a format rule (e.g., a paragraph rule, an identification rule, etc.), and the final translated content may be obtained. For example, the segmented sentences of the pre-translated content may be returned to be consistent with the content to be translated. More detailed description about operation 330 may refer to FIGS. 6 and 7 and descriptions thereof, which are not described herein again.

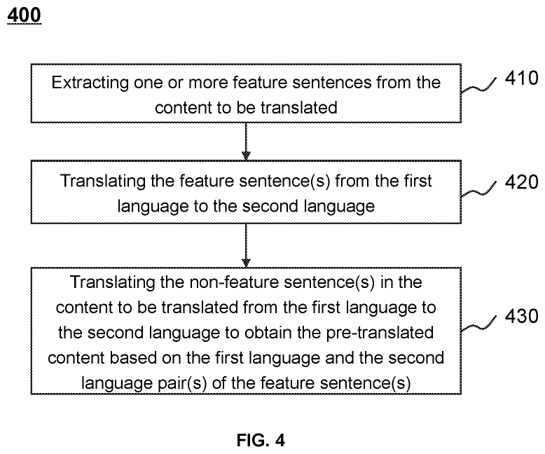

FIG. 4 is a flowchart illustrating an exemplary process for pre-translation according to some embodiments of the present disclosure. In some embodiments, the pre-translated process 400 may be implemented by the processing device 112. As shown in FIG. 4, the pre-translation process 400 may include ops described below.

In 410, one or more feature sentences may be extracted from the content to be translated. Specifically, operation 410 may be performed by the feature sentence extraction unit.

A feature sentence may be a word, a phrase, or a sentence with certain feature(s). The feature sentence(s) may be extracted based on a matching degree between words, phrases or sentences in the content to be translated and the corpus, a specific rule, a count of words, phrases or sentences present in the content to be translated, a similarity of words, phrases or sentences in the full content of the content to be translated, and other manually determined processes.

In some embodiments, the feature sentence(s) may be one or more words, phrases, or sentences of the content to be translated, a matching degree of each of which is greater than or equal to a preset matching degree. The matching degree refers to a degree that content matches content existing in a corpus, and may be in a form of a percentage, a decimal, a fraction, or the like. The corpus refers to one-to-one language pairs corresponding to the first language and the corresponding second language, including, but not limited to, words, phrases, or sentences. The corpus includes one or more language pairs. The corpus may be obtained before the content to be translated is obtained. The corpus may be stored in the database 140 or other storage devices.

The feature sentence extraction unit may extract the feature sentence(s) based on the matching degree. The feature sentence extraction unit may compare the content to be translated with the corpus sentence by sentence to obtain the matching degree of each sentence, and display the matching degree of each sentence. The range of the matching degree may be 0-1.0. The matching degree may reflect the similarity of two sentences. If there is no match, the matching degree is 0, and the terminal does not display the matching degree and the content in the corpus. If the two sentences are matched at 100%, the matching degree is 1.0, and the terminal displays the matching degree of 1.0 and the content at the matching degree of 100% in the corresponding corpus.

The matching degree may be calculated by establishing a word mapping relationship and calculating the ratio of a count of computable maps to a total count of words. The matching degree may be calculated by other rules, or a machine learning model.

When the matching degree is greater than or equal to the preset matching degree, the feature sentence extraction unit may extract sentence(s) greater than or equal to the preset matching degree as the feature sentence(s). The preset matching degree may be a system default value or set by a user, for example, 0.8, 0.9, 0.95, or the like. When one or more contents to be translated includes one or more same sentences, the first language of these sentences may be translated into the second language in advance to make a corpus, and the corpus may be stored in the database 140. After, when the content to be translated includes these same sentences, the feature sentence extraction unit may extract these sentences as the feature sentences according to the matching degree.

In some embodiments, the feature sentence(s) may be sentence(s) with the specific rule. The feature sentence extraction unit may extract the feature sentence(s) based on the specific rule. The specific rule may be stored in the database 140. For example, the specific rule may be defined according to grammatical rules of the first language in the content to be translated.

In some embodiments, the specific rule may include only the first language, and may also include a corresponding relationship between the first language and the translated second language as a corresponding translation rule. The specific rule may include a feature extraction rule and a translation rule. For example, when the first language is English and the second language is a Chinese, “FIG. X” may be defined as “ [symbol] X”, wherein X represents any number. Then, “FIG.X” is a feature extraction rule, and “FIG.X”-“ [symbol] X” is a translation rule.

As another example, when the first language is Chinese and the second language is English, “relating to N” may be defined as “ [symbol] N [symbol] ”, wherein N represents a word or phrase. Then, “relating to N” is a feature extraction rule, and “relating to N”-“ [symbol] N [symbol] ” is a translation rule.

The specific rule may be stored in the database 140 or stored in other devices. When the feature sentence extraction unit recognizes a sentence in the first-language that meets the specific rule, the sentence may be extracted as a feature sentence.

In some embodiments, the feature sentence(s) may be one or more words, phrases, or sentences in the content to be translated, a count of each of which in the full text is greater than a threshold. The feature sentence extraction unit may first extract candidate feature sentence(s) based on the count, and then extract the feature sentence(s) from the candidate feature sentence(s). After the content to be translated is obtained, the feature sentence extraction unit may calculate the count of the words, phrases, and sentences in the entire text. For example, a count of nouns or noun phrases may be counted and listed in a descending order. When the count of the nouns or the noun phrases is greater than or equal to the threshold, the feature sentence extraction unit may extract these nouns and noun phrases as the feature sentences. The feature sentence extraction unit may extract a feature sentence from the candidate feature sentences when the count of the feature sentence is greater than or equal to the threshold. The threshold may be the system default or set by a user, for example, 3, 5, 7, etc.

In some embodiments, the feature sentence(s) may be word(s), phrase(s), or sentence(s) in the content to be translated that have the similarity. The feature sentence extraction unit may extract the feature sentences based on the similarity. The similarity refers to the degree of similarity between words, phrases, and sentences. After obtaining the content to be translated, the feature sentence extraction unit may perform matching on the sentences of the entire content and calculate the similarity therebetween. Then, the similarity may be ranked in ranges of, for example, 90%-100%, 80%-90%, 70%-80%, etc. The user may select the similarity of the one or more ranges, and the feature sentence extraction unit may extract the feature sentence(s) belonging to a selected interval as the feature sentence(s).

In some embodiments, the feature sentence(s) may also be manually determined words, phrases, or sentences. The feature sentence(s) may be simple sentence(s), familiar sentence(s), or sentence(s) that are relatively strong in the professional area, or the like, or any combination thereof. In some cases that the matching degree between each of the feature sentence(s) determined by the user and the corpus is not within a preset range of the matching degree, and the count of the feature sentence(s) in the content is less and have no rule, the feature sentence(s) may be extracted by the user.

In 420, the feature sentence(s) may be translated from the first language to the second language. Specifically, operation 420 may be performed by the feature sentence translation unit.

In some embodiments, when the feature sentence(s) are words, phrases, or sentences having the matching degree with the corpus greater than or equal to the preset matching degree, the feature sentence(s) may be translated by using the corpus. Specifically, a feature sentence may be matched with the corpus in the database 140 to select a sentence with the highest matching degree, and perform translation on the feature sentence based on the sentence, for example, some content may be modified, deleted or added.

In some embodiments, when the feature sentence(s) are sentence(s) with specific rule(s), the feature sentence translation unit may translate the feature sentence(s) using a preset rule. For example, when the feature sentence extraction unit extracts “FIG. 2” in the content to be translated, the feature sentence translation unit 424 may translate “FIG. 2” into “FIG. 2” according to a specific rule “FIG.X”-“ [symbol] 2”.

In some embodiments, the feature sentence translation unit may translate the extracted feature sentence(s) (for example, the matching degree with the corpus is 0.5 or more) by the corpus. In some embodiments, the feature sentence translation unit may translate the extracted feature sentence(s) by a dictionary and/or translation engine (e.g., Google Translate, Baidu Translate, Sogou Translate, etc.). In some embodiments, the feature sentence(s) may also be translated by the user. In some embodiments, the feature sentence(s) may be translated by a combination of the user and the corpus, the dictionary and/or the translation engine. In some embodiments, the machine learning model may be used to translate the feature sentence(s). More detailed description about the machine learning model may refer to FIG. 5 and description thereof.

In some embodiments, the feature sentence(s) may also be translated by a specific context or area. Specifically, the same sentence may have different translation results in different situations (for example, different areas and different contexts). The feature sentence translation unit may use one or more built-in dictionaries, one or more built-in translation engines, etc. to translate the feature sentence(s) according to a specific context or domain.

Additionally or alternatively, after the feature sentence(s) are translated into the second language, the feature sentence(s) may also be identified, for example, highlighting, bolding, or adjusting the font format, so that the user may clearly know when checking the final translated content, which is convenient for revision.

In 430, based on the first language and the second language pair(s) of the feature sentence(s), the non-feature sentence(s) in the content to be translated may be translated from the first language to the second language to obtain the pre-translated content. Specifically, operation 430 may be performed by the pre-translation determination unit.

The pre-translation determination unit may determine whether the feature sentence(s) are partially or completely translated into the second language, and the pre-translated content may be obtained by translating the remaining non-feature sentence(s) (for example, the content other than the feature sentence(s) that have been translated into the second language) in the content to be translated from the first language into the second language.

In some embodiments, if a feature sentence is a word or phrase and a sentence includes the feature sentence, the feature sentence in the sentence may have been translated into the second language (refer to operation 420), and the rest of the sentence (that is, non-feature sentence) is the first language. The pre-translation determination unit may translate the rest non-feature sentence from the first language to the second language by determining whether the feature sentence is partially translated into the second language. The translated second language may be kept in the sentence, and the first language of the rest non-feature sentence may be translated into the second language.

In some embodiments, if a feature sentence is an entire sentence, the feature sentence may have been fully translated into the second language (refer to operation 420). The pre-translation determination unit may determine that the sentence has been translated by determining whether the feature sentence is fully translated into the second language, that is, the second language in the feature sentence does not include the first language. In this case, the sentence may be skipped or the sentence may be copied to the corresponding position of the pre-translated content.

In some embodiments, if a sentence does not include or is not a feature sentence, the pre-translation determination unit may determine that the sentence does not include the second language, and translate the first language in the sentence into the second language.

In some embodiments, the pre-translation determination unit may translate the first language of the non-feature sentence(s) into the second language by using the translation engine.

In some embodiments, the pre-translation determination unit may translate the first language of the non-feature sentence(s) into the second language by the corpus. For example, if the matching degree of a non-feature sentence with the corpus is between 70%-90%, the content between 70%-90% may be matched, and the remaining content between 30%-10% may be revised by the user.

In some embodiments, the pre-translation determination unit may translate the first language of the non-feature sentence(s) into the second language by constructing a machine learning model and training the machine learning model. In one embodiment, the content to be translated in the first language and the machine learning model may be obtained, the content to be translated in the first language may be input as an input into the machine learning model, and the pre-translated content in the second language may be output. More detailed description about translating the first language by the machine learning model may refer to FIG. 5 and description thereof, which will not be repeated here.

Additionally or alternatively, when the pre-translation determination unit translates the first language of the content to be translated into the second language, the pre-translation determination unit may perform format processing on the content to be translated. The format processing may include sentence segmentation, replacing the specific expression of the original content, or the like.

The sentence segmentation may insert some special symbol(s) after the period to make a large section of the content segmented by the period. During such segmentation, the positions of the segmented sentences may be recorded. For example, the special symbol(s) may be added to the segmented sentence(s). The special symbol(s) may be #, *, @, or the like. As another example, the positions of the added segmented sentences may be recorded.

The readability of the content may be increased by sentence segmentation.

The replacement of the specific expression of the original content may be to directly replace some of the error-prone or missed first language in the content to be translated with the second language and record it. The way of recording may be to add special marks, for example, use parentheses to mark the second language. Merely by way of example, in patent translation, some “the” in the claims need to be translated into “ [symbol] ”, the “the” in the claims may be replaced with “[the]”, and “[the]” is still “[the]” after being processed by a translation engine. “[the]” may be used to remind the user that they need to pay attention to whether the position of “ [symbol] ” is correct, whether there is any omission of “ [symbol] ”, etc. The way of recording is also to save the corresponding position.

FIG. 5 is a flowchart illustrating an exemplary process for training a model according to some embodiments of the present disclosure. In some embodiments, the module training process 500 may be implemented by the processing device 112. As shown in FIG. 5, the module training process 500 may include operations described below.

In 510, the language pair(s) of the first language and the second language may be obtained from the historical translated content. Specifically, operation 510 may be performed by the training module 240.

In the historical translated content, the first language has been translated into the second language. The historical translated content refers to content translated from the first language to the second language and obtained in various ways, including, but not limited to, content previously translated by the user, revised content, translation materials from various sources (for example, the Internet), etc. The first language and the second language of the history translated content may be in the same document, or in different documents. In the same document, the first language and the second language of the historical translated content may also be in the form of bilingual comparison sentence by sentence, or in the form of bilingual comparison paragraph by paragraph.

The training module 240 may obtain historical translated content from a database, or import or obtain historical translated content by an application program interface or a network. After obtaining the historical translated content, the training module 240 may make language pair(s) of the first language and the second according to the corresponding relationship between the first language and the second language. The language pair(s) may include a sentence, a phrase, a term, a word of a specific content type, a word, sentence, or paragraph of a specific area, or the like, or any combination thereof. The language pair(s) may also include the first language and the second language of long and difficult sentence(s) (also referred to as high-risk sentence(s)). The language pair(s) may also include the first language of the high-risk sentence(s) and the second language with identification. The identification includes changing font color, changing font size, changing font style, adding symbols, or the like, which may refer to operation 620 and description thereof, and herein are not described again. The language pair(s) may also include a translation result of the second language of the high-risk sentence(s) and a revision result of the second language.

In 520, the machine learning model may be trained based on the language pair(s). Specifically, operation 520 may be performed by the training module 240.

The machine learning model may be an artificial neural network (ANN) model, a recurrent neural network (RNN) model, a long short-term memory network (LSTM) model, a bidirectional recurrent neural network (BRNN) model, a sequence-to-sequence (Seq2Seq) model, and other models available for machine translation, or any combination thereof. The initial machine learning model may have predetermined default values (e.g., one or more parameters) or may be variable in some cases. The training module 240 may train the machine learning model by a machine learning algorithm, which may include, but not limited to, an artificial neural network algorithm, a recurrent neural network algorithm, a long short-term memory network algorithm, a deep learning algorithm, a bidirectional recurrent neural network algorithm, etc., or any combination thereof.

Specifically, the training module 240 may input the first language of historical translated content into the machine learning model, and obtain a sample second language. The initial machine learning model may have predetermined default values (e.g., one or more parameters) or may be variable in some cases. The sample second language may be compared with the second language of the historical translated content to determine a loss function. The loss function may represent the accuracy of the trained machine learning model. The loss function may be determined by the difference between the sample second language and the second language of the historical translated content. The difference may be determined based on an algorithm.

The training module 240 may determine whether the loss function is less than the training threshold. If the loss function is less than the training threshold, the machine learning model may be determined as a trained machine learning model. The training threshold may be a predetermined default value or may be variable in some cases. If the loss function is greater than or equal to the training threshold, the first language of the historical translated content may be input into the machine learning model until the loss function is less than the training threshold, and the machine learning model at this time may be determined as the trained machine learning model.

In some embodiments, different types of language pairs may be used as input and output to obtain different machine learning models, but the training processes may be similar to the training process described above. The second language including the high-risk sentence(s) and the second language manually corrected may be used as inputs and outputs to train machine learning models and obtain trained machine learning models for correcting the high-risk sentence(s). It should be noted that the inputs and inputs may be used to train machine learning models separately to obtain a plurality of machine learning models, and the inputs and outputs may be used to train a machine learning model to obtain a machine learning model outputting different results.

In some embodiments, a classification model may be trained to determine the classification of the first language or the second language, and the corresponding machine learning model may be used for translation according to the classification. A plurality of models may be used to translate the same sentences and fuses their translation results according to certain algorithms. Rules may be used to translate specific sentences in certain classification.

In 530, more new language pairs may be obtained in a certain period of time. Specifically, operation 530 may be performed by the training module 240.

The training module 240 may need to obtain new language pairs in a certain period of time. The certain period of time may be 5 days, 7 days, half a month, or the like. More new language pairs may be obtained by obtaining more historical translated contents from the database, the input terminal, and/or other terminals.

In 540, the machine learning model may be trained and updated based on the new language pairs. Specifically, operation 540 may be performed by the training module 240.

After acquiring the new language pairs, the training module 240 may need to train and update the machine learning model based on the new language pairs. That is, the first language in the new language pairs may be input as an input into the trained machine learning model, the operations of training the machine learning model in step 530 may be repeated, and then the machine learning model may be updated.

FIG. 6 is a flowchart illustrating an exemplary process for determining a final translation content according to one of the embodiments disclosed in the present disclosure. Specifically, the process 600 for determining the final translated content may be implemented by the revision module 230.

In 610, the high-risk sentence(s) may be determined based on the content to be translated. Specifically, operation 610 may be determined by the high-risk sentence termination unit.

The high-risk sentence determination unit may determine the high-risk sentence(s) based on a rule. The rule may include a sentence length, a count of prepositions, transition words, error-prone words, or polysemes in a sentence, or the like, or any combination thereof.

In some embodiments, the high-risk sentence(s) may be sentence(s) in which the count of characters or words exceeds a preset threshold. The high-risk sentence determination unit may determine the high-risk sentence(s) by determining the count of characters or the count of words in a sentence. For example, if the count of characters or words in a sentence exceeds the preset threshold, it may be determined that the sentence is a high-risk sentence. The preset threshold may be set by the user or determined by the translation system 100. For example, the preset threshold may be 15, 20, 30, etc.

In some embodiments, the high-risk sentence(s) may be sentences including relatively more risk words. A risk word may include a preposition, a transition word, an error-prone word, or a polysemy. Taking Chinese and English as examples, the preposition may be “by”, “after”, “through”, “ [symbol] . . . [symbol] ”, “ [symbol] . . . [symbol] ”, etc., and the transitional word may be “however”, “but”, “ [symbol] ”, “ [symbol] ”, etc., the error-prone words may be words or phrases that are prone to error, and can be determined in advance based on experience. The polysemy may be a word or phrase with multiple meanings, for example, “object”, “apply”, “feature”, or the like.

The risk words may be determined by a set rule or vocabulary, a semantic model, or a customized machine learning classification model.

The high-risk sentence determination unit may determine the high-risk sentence(s) by determining the count of these words in a sentence. For example, when the count of one or more words being a preposition, a transition word, an error-prone word, or a polysemy exceeds the preset threshold, it may be determined that the sentence is a high-risk sentence. The preset threshold may be 5, 7, 9, or the like.

The threshold may be determined based on the sum of the risk words in a sentence, or based on the count of risk words of each type in a sentence. When determined according to multiple types of values, the threshold may be determined by using processes such as weighted summation, weighted average, a preset condition rule, a state machine, or a decision tree.

The high-risk sentence determination unit may use one or more high-risk sentence recognition models to determine the high-risk sentence(s). The high-risk sentence recognition model may be a Bayesian prediction model, a decision tree model, a neural network model, a support vector machine model, a K nearest neighbor algorithm (KNN) model, a logistic regression model, or the like, or any combination thereof. Each of the high-risk sentence recognition models may be trained by taking the first language that includes high-risk sentences and non-high-risk sentences in the historical content to be translated as an input, and whether each sentence is a high-risk sentence as an output, and the trained high-risk sentence recognition models may be obtained. After the content to be translated is input into each trained high-risk sentence recognition model, the model may classify the sentences in the content to be translated according to the calculated value. For example, if a sentence exceeds a certain threshold, it may be determined that the sentence is a high-risk sentence; otherwise, it is a non-high-risk sentence. The threshold may be a predetermined default value or may be variable in some cases. The high-risk sentence(s) may be relatively more complicated sentence(s), and the relatively more complicated sentence(s) may include a relatively more complicated grammar (for example, including two or more clauses), a sentence utterance, or the like.

In some embodiments, the models may also be regression models. During training, manually calibrated risk coefficients or statistically obtained risk coefficients may be used as labels.

In some embodiments, the high-risk sentence determination unit may use the multiple high-risk sentence recognition models to determine the high-risk sentence(s). For example, the first language that includes high-risk sentences and non-high-risk sentences in the historical content to be translated may be taken as the input, and the determined high-risk sentences and non-high-risk sentences may be taken as the output to train the multiple high-risk sentence recognition models simultaneously in order to obtain the multiple trained high-risk sentence recognition models. Then, the content to be translated may be input into different high-risk sentence recognition models, and the values calculated by these models may be calculated to obtain the final values. If a final value is less than the set threshold, a sentence may be not a high-risk sentence. If a final value is greater than or equal to the set threshold, the sentence may be considered as a high-risk sentence. The calculated values may be obtained through a weighted average, a weighted sum, other non-linear equations, other rules, a decision tree, or a calculation based on a machine learning model. As another example, documents to be translated may be input into one of the high-risk sentence recognition models (for example, a decision tree model), and sentences greater than or equal to a set threshold calculated by the decision tree model may be continuously input into one of other high-risk sentence recognition models. If the result of a sentence calculated this time is still greater than or equal to a set threshold, the sentence may be determined as a high-risk sentence. If the sentence is less than the set threshold, the sentence may continuously be input into the next high-risk sentence recognition model. If the calculation result is greater than or equal to a set threshold, the sentence may be determined as a high-risk sentence, otherwise the sentence may be determined as a non-high-risk sentences. In some embodiments, the thresholds associated with each high-risk sentence recognition model may be the same or different.

In some embodiments, the high-risk sentence determination unit may also determine high-risk sentence(s) by combining the rule with the one or more high-risk sentence recognition models. For example, an average value may be determined for a sentence by averaging a value calculated by the rule and a value calculated by the one or more machine learning models. If the average value is greater than or equal to a set threshold, the sentence may be determined as a high-risk sentence. As another example, a minimum value between the value calculated by the rule and the value calculated by the one or more machine learning models may be determined. If the minimum value is greater than or equal to the set threshold, the sentence may be determined as a high-risk sentence. The value calculated by the one or more machine learning models may be one or more values. For example, each of these values may be calculated by each of the models, that is, one value may correspond to one machine learning model, or the value may be a weighted average, a minimum, a maximum, etc. of all models.

In 620, the sentence(s) in the second language corresponding to the high-risk sentence(s) may be identified in the pre-translated content. Specifically, operation 620 may be executed by the high-risk sentence revision unit.

After determining the high-risk sentence(s) in the content to be translated, the pre-translation module 220 may pre-translate the high-risk sentence(s). In some embodiments, the pre-translation may include translating the high-risk sentence(s) using the machine learning model described in FIG. 5. For example, a large number of the first and second language pairs of historical contents to be translated may be used as input and output to train a machine learning model, and then the trained machine learning model may be used to pre-translate the first language of the high-risk sentence(s) to output the second language corresponding to the first language of the high-risk sentence(s). In some embodiments, the existing translation engines may also be used to translate the high-risk sentence(s). In some embodiments, if a high-risk sentence matches the corpus to a matching degree (for example, greater than 50%), the high-risk sentence may be revised based on the corpus.

The high-risk sentence revision unit may also identify the sentence(s) in the second language corresponding to the high-risk sentence(s) in the pre-translated content. After the high-risk sentence(s) in the content to be translated is determined in operation 610, the high-risk sentence revision unit may identify the corresponding translated second language according to the first language of the high-risk sentence(s) determined in the content to be translated. The identifying may include changing a font color, changing a font size, changing a font style, adding symbols, or the like. For example, if the font color of the pre-translated content is black, the high-risk sentence(s) may be changed to red. As another example, if the font size of the pre-translated content is small four, the font size of the high-risk sentence may be changed to four. As a further example, if the font in the pre-translated content is Song Typeface, the high-risk sentence(s) may be changed to regular script. Symbols may be also added before and after the high-risk sentence(s), such as @, # and *, which may be different from the special symbol(s) for the sentence segmentation. The result of identifying the second language of the high-risk sentence(s) may be different from the result of identifying the second language of the feature sentence(s). The present disclosure may be not limited to the identification process, any other process that may identify the high-risk sentence(s) may be within the scope of the present disclosure.

In some embodiments, the high-risk sentence revision unit may also provide a plurality of translation results of the second language of the high-risk sentence(s) for the user to select an appropriate translated content. Further, a machine learning model may be used to output a plurality of translation results. For example, a machine learning model may be used to translate the high-risk sentence(s) multiple times, or a plurality of machine learning models may be used to output a plurality of translation results in the second language. For example, the high-risk sentence(s) may be translated multiple times by setting a count of translations, for example, 3, 5, 7, etc. In some embodiments, the count of translation results of the second language may be less than or equal to the count of translations, and greater than or equal to 1. For example, if a high-risk sentence is translated 5 times, 5 translation results or 4 translation results may be output.

In some embodiments, a confidence level corresponding to each translation result may be output when a plurality of translation results of the high-risk sentences are provided. The confidence level may represent the accuracy of each translation result by a machine learning model. The higher the confidence level, the higher the probability of accurate translation result. The confidence level may be in the form of a numerical value, a percentage, a score, or the like. Specifically, the confidence level may be obtained using a process such as BLEU, NIST, or the like. The output translation results may be sorted according to the confidence levels corresponding to each translation result, and may be sorted in an ascending or descending order.

In some embodiments, the translation results of the high-risk sentences may be also output according to a set confidence level threshold. For example, when the confidence level of a translation result of a high-risk sentence is less than the confidence level threshold, the translation result may be not output. Only one or more translation results of the high-risk sentence that are greater than or equal to the confidence level threshold may be output. If the translation results of the high-risk sentences are less than the confidence level threshold, only a translation result with the maximum confidence level may be output.

In 630, the final translated content of the high-risk sentence(s) (i.e., an output content 130) may be determined based on the pre-translated content of the high-risk sentence(s). Specifically, operation 630 may be performed by the high-risk sentence revision unit.

In some embodiments, the high-risk sentence revision unit may determine the translation result(s) of the high-risk sentence(s) in the second language. Determining the translation result(s) of the high-risk sentence(s) in the second language may include correcting the translation result(s) in the second language, for example, manual correction, using a machine learning model, or the like.

In some embodiments, the user may correct and revise the translation results of these high-risk sentences to obtain a more accurate second language, for example, adjusting the order of sentences, revising the expression of words, etc. In some embodiments, a machine learning model may be used to correct the translation of high-risk sentence(s). The machine learning model may be trained by using the second language of high-risk sentences in the historical content to be translated and the corrected second language as an input and output respectively to obtain a trained machine learning model. Specifically, the machine learning model may identify the second language of the high-risk sentence(s) needing to be corrected, and determine whether the second language content of the corrected part matches the other pre-translated content. If not, the meaning of the corresponding first language that matches the other pre-translated content may be selected and replace the original second language content; if yes, this operation may be skipped. Merely by way of example, the second language content that needs to be corrected may be “4 [symbol] ”, and the corresponding first language may be “4 seconds”. The machine learning model may determine that the second language content does not match with the other pre-translated content, and select the other meaning “ [symbol] ” of “seconds” associated with a number, and then changes “ [symbol] ” to the “ [symbol] ”.

The high-risk sentence revision unit may correct the translation result(s) based on the confidence level(s). For example, if a confidence level of a translation result of a high-risk sentence is 1, the translation result of the high-risk sentence may be not corrected. As another example, a translation result with a maximum confidence level of the high-risk sentence less than or equal to a certain threshold may be corrected.

FIG. 7 is a flowchart illustrating an exemplary process for partially determining a final translated content according to some embodiments of the present disclosure. Specifically, the process shown in FIG. 7 may be determined by the format revision unit. The process shown in FIG. 7 may be mainly used to adjust the format of the pre-translated content.

The process for determining the final translated content described in FIG. 7 may be performed successively with other processes for determining the final translated content.

In 710, a format rule of the final translated content may be obtained.

The format rule may include a paragraph rules, an identification rule, or the like. The paragraph rule may include performing sentence segmentation on the content of the first language, the first language and the second language being in a contrast format, the first language and the second language being in a non-contrast format, or the like. The first language and the second language being in a non-contrast format may include the first language and the second language being in one document, or not in one document. The identification rule may include a result of identifying the second language of the high-risk sentence(s), such as changing a font color, changing a font size, changing a font style, adding symbols, or the like.

The format revision unit may obtain the format rule from the final translated content. In some embodiments, the format revision unit may identify whether the final translated content includes special symbols of sentence segmentation, thereby determining whether sentence segmentation is performed on the first language and the second language. The format revision unit may also identify whether the final content includes a first language corresponding to a second language, or the like, thereby determining whether the first language and the second language are in a contrast format or a non-contrast format.

In 720, the final translated content may be determined based on the format rule. The format revision unit may adjust the format of the pre-translated content according to the format rule determined in operation 710 to obtain the final translated content.

In some embodiments, if a format rule is to delete special symbols of sentence segmentation, these special symbols may be deleted, and then the preceding and following sentences of these special symbols may be merged. At this time, the format of the final translated content may be consistent with the paragraph format in the first language. Additionally or alternatively, if the format rule for revision is to delete the first language content for contrast, the first language content may be deleted, and there may be only the translation result in the second language.

It should be noted that the above description regarding the processes 400, 500, 600, and 700 are merely provided for the purpose of illustration, and not intended to limit the scope of the present disclosure. For persons having ordinary skilled in the art, multiple variations and modifications may be made for the processes 400, 500, 600, and 700 under the teachings of the present disclosure. However, those variations and modifications do not depart from the scope of the present disclosure. For example, the process 400 may be omitted, and the first language may directly be translated into the second language without extracting a feature sentence. Operation 630 may be omitted, and high-risk sentences may be not corrected, and the final translated content may directly be determined. The process 700 may be omitted, and the final translated content may directly be output without correction to be consistent with the format of the content to be translated.

The beneficial effects that the embodiments of the present disclosure may include, but not limited to: (1) through special translation of feature sentences, the words in the translated content may be consistent, and the same content in multiple content to be translated may be directly translated, so that the results of the machine translation is consistent, saving manual revision time; (2) the high-risk sentence(s) may be seen in the final translated content by identifying the high-risk sentence(s), and a plurality of confidence levels and a plurality of translation results may be output for user reference, which greatly improves the efficiency of manual revision; (3) the translation quality of the high-risk sentence(s) may be improved in a targeted manner by using multiple models for translation; and (4) it is convenient for a user to view and compare the first language and the second language during manual revision by using automatic format processing, thereby greatly improving translation efficiency, and reducing the workload of format return. It should be noted that different embodiments may have different beneficial effects. In different embodiments, the possible beneficial effects may be any one or any combination thereof, or any other beneficial effects that may be obtained.

Having thus described the basic concepts, it may be rather apparent to those skilled in the art, the foregoing detailed disclosure may be intended to be presented by way of example only and may be not limiting for the present disclosure. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “data block”, “module”, “engine”, “unit”, “component” or “system”. Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that may be not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, may be not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially”. Unless otherwise stated, “about,” “approximate,” or “substantially” may indicate ±20% variation of the value it describes. Accordingly, in some embodiments, the numerical parameters set forth in the description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters configured to illustrate the broad scope of some embodiments of the present disclosure are approximations, the numerical values in specific examples may be as accurate as possible within a practical scope.

Each patent, patent application, patent application publication and other materials cited herein, such as articles, books, instructions, publications, documents, etc., are hereby incorporated by reference in their entirety. The content of the application history that is inconsistent with or conflicting with the content of the present disclosure is excluded, as is the content with the broadest scope of the present disclosure claims (currently or later added to the present disclosure). It should be noted that if the description, definition, and/or terms used in the appended application of the present disclosure is inconsistent or conflicting with the content described in the present disclosure, the use of the description, definition and/or terms of the present disclosure shall prevail.

At last, it should be understood that the embodiments described in the present disclosure are merely illustrative of the principles of the embodiments of the present disclosure. Other modifications may be within the scope of the present disclosure. Accordingly, by way of example, and not limitation, alternative configurations of embodiments of the present disclosure may be considered to be consistent with the teachings of the present disclosure. Accordingly, embodiments of the present disclosure are not limited to the embodiments that are expressly introduced and described herein.

1. A translation method, comprising:
obtaining a content to be translated in a first language;
translating the content to be translated in the first language into a pre-translated content including a second language;
correcting the pre-translated content including the second language; and
determining a final translated content based on a correction result.

2. The translation method of claim 1, wherein translating the content to be translated in the first language into a pre-translated content including a second language comprises:
extracting one or more feature sentences from the content to be translated;
obtaining one or more sentence pairs including the one or more feature sentences in the first language and the one or more feature sentences in the second language translated from the first language; and
translating the content to be translated in the first language into the pre-translated content including the second language based on the one or more sentence pairs of the one or more feature sentences.

3. The translation method of claim 1, wherein correcting the pre-translated content including the second language comprises:
determining whether the pre-translated content includes a high-risk sentence; and
in response to a determination that the pre-translated content includes the high-risk sentence, identifying a sentence in the second language corresponding to the high-risk sentence.

4. The translation method of claim 3, wherein determining whether the pre-translated content includes a high-risk sentence comprises:
determining whether the pre-translated content includes a sentence with a count of characters or words exceeding a preset threshold; or
determining whether the pre-translated content includes a sentence with a count of risk words exceeding a preset threshold.

5. The translation method of claim 3, further comprising:
translating the first language of the high-risk sentence into one or more translation results in the second language;
determining one or more confidence levels of the one or more translation results in the second language, each of which corresponds to a confidence level; and
displaying the one or more confidence levels, or
determining a final translated content of the high-risk sentence based on the confidence levels of the one or more translation results in the second language.

6. The translation method of claim 1, further comprising:
performing sentence segmentation on the pre-translated content; and
performing sentence return on the final translated content.

7. A translation system, comprising an obtaining module, a pre-translation module and a revision module, wherein
the obtaining module is configured to obtain a content to be translated in a first language;
the pre-translation module is configured to translate the content to be translated in the first language into a pre-translated content including a second language; and
the revision module is configured to correct the pre-translated content including the second language and determine a final translated content based on a correction result.

8. The translation system of claim 7, wherein to translate the content to be translated in the first language into a pre-translated content including a second language, the pre-translation module is further configured to:
extract one or more feature sentences from the content to be translated;
obtain one or more sentence pairs including the one or more feature sentences in the first language and the one or more feature sentences in the second language translated from the first language; and
translate the content to be translated in the first language into the pre-translated content including the second language based on the one or more sentence pairs of the one or more feature sentences.

9. The translation system of claim 7, wherein to correct the pre-translated content including the second language, the revision module is further configured to:
determine whether the pre-translated content includes a high-risk sentence; and
in response to a determination that the pre-translated content includes the high-risk sentence, identify a sentence in the second language corresponding to the high-risk sentence.

10. The translation system of claim 9, wherein to determine whether the pre-translated content includes a high-risk sentence, the revision module is further configured to:
determine whether the pre-translated content includes a sentence with a count of characters or words exceeding a preset threshold; or
determine whether the pre-translated content includes a sentence with a count of risk words exceeding a preset threshold.

11. The translation system of claim 9, wherein
the pre-translation module is configured to:
translate the first language of the high-risk sentence into one or more translation results in the second languages; and
the revision module is configured to:
determine one or more confidence levels of the one or more translation results in the second language, each of which corresponds to a confidence level; and
display the one or more confidence levels, or
determine a final translated content of the high-risk sentence based on the confidence levels of the one or more translation results in the second language.

12. The translation system of claim 7, wherein
the pre-translation module is configured to:
perform sentence segmentation on the pre-translated content; and
the revision module is configured to:
perform sentence return on the final translated content.

13. (canceled)

14. A computer-readable storage medium storing computer instructions, wherein when reading computer instructions in the storage medium, a computer executes operations comprising:
obtaining a content to be translated in a first language;
translating the content to be translated in the first language into a pre-translated content including a second language;
correcting the pre-translated content including the second language; and
determining a final translated content based on a correction result.

15. The computer-readable storage medium of claim 14, wherein translating the content to be translated in the first language into a pre-translated content including a second language comprises:
extracting one or more feature sentences from the content to be translated;
obtaining one or more sentence pairs including the one or more feature sentences in the first language and the one or more feature sentences in the second language translated from the first language; and
translating the content to be translated in the first language into the pre-translated content including the second language based on the one or more sentence pairs of the one or more feature sentences.

16. The computer-readable storage medium of claim 14, wherein correcting the pre-translated content including the second language comprises:
determining whether the pre-translated content includes a high-risk sentence; and
in response to a determination that the pre-translated content includes the high-risk sentence, identifying a sentence in the second language corresponding to the high-risk sentence.

17. The computer-readable storage medium of claim 16, wherein determining whether the pre-translated content includes a high-risk sentence comprises:
determining whether the pre-translated content includes a sentence with a count of characters or words exceeding a preset threshold; or
determining whether the pre-translated content includes a sentence with a count of risk words exceeding a preset threshold.

18. The computer-readable storage medium of claim 16, further comprising:
translating the first language of the high-risk sentence into one or more translation results in the second language;
determining one or more confidence levels of the one or more translation results in the second language, each of which corresponds to a confidence level; and
displaying the one or more confidence levels, or
determining a final translated content of the high-risk sentence based on the confidence levels of the one or more translation results in the second language.

19. The computer-readable storage medium of claim 14, further comprising:
performing sentence segmentation on the pre-translated content; and
performing sentence return on the final translated content.
